(19) United States
(12) Patent Application Publication
(10) Pub. No.: US 2007/0189272 A1
(43) Pub. Date: Aug. 16, 2007

(54) DEVICE ANALYSIS SYSTEM FOR TRACKING DEVICE OPERATIONS WITHIN A WIRELESS NETWORK

(75) Inventors: JEFFREY HUTCHINSON, RENTON, WA (US); DAVID B. MCKINLAY, MAPLE VALLEY, WA (US)

Correspondence Address: HOWISON & ARNOTT, L.L.P, P.O. BOX 741715, DALLAS, TX, 75374-1715, US

(73) Assignee: CYPHEREDGE TECHNOLOGIES, BELLEVUE, WA (US)

(21) Appl. No.: 11/470,567

(22) Filed: Sep. 6, 2006

Related U.S. Application Data
(63) Continuation-in-part of application No. 11/352,922, filed on Feb. 10, 2006.
Application No. 11/352,922 is a continuation-in-part of application No. 11/353,297, filed on Feb. 10, 2006.

(51) Int. Cl. H04L 12/66

(52) U.S. Cl. 370/352

(57) ABSTRACT

A system for tracking handset operations within a wireless network includes an interface with a database containing call data relating to handset operations wherein the call data is collected from various call data records. An extraction module analyzes the call data within the database to obtain mobile originating call data and mobile terminating call data responsive to designated filter conditions. The mobile originating call data and mobile terminating call data are stored within a second database. A user interface enables a user to create the designated filter conditions and utilize the mobile originating call data and mobile terminating call data to provide at least one handset report describing the operation of at least one handset.

### CROSS-REFERENCE TO RELATED APPLICATIONS

This application is a continuation-in-part of U.S. patent application Ser. No. ______ entitled “METHOD FOR CREATING A DATA REPOSITORY FROM DISPARATE SOURCES OF SUBSCRIBER BEHAVIORAL DATA IN COMMUNICATIONS NETWORKS” (Attorney Docket No. CYPH-27,500), and U.S. patent application Ser. No. ______ entitled “SYSTEM FOR COMPILING DATA FROM CALL EVENT INFORMATION” (Attorney Docket No. CYPH-27,436), respectively, which are each incorporated herein by reference.

### TECHNICAL FIELD OF THE INVENTION

The present invention relates to data management systems, and more particularly, to a data management system for use with wireless communication systems.

### BACKGROUND OF THE INVENTION

The wireless industry is growing at an astonishing pace. Increasing competitive pressures for efficiencies in retaining customers are paramount. With intricate and variable networks moving information long distances, potential loss of revenue producing data occurs. The challenge for a network operator is to identify, isolate and correct problems and inefficiencies. The more optimized the network, the more revenue to be generated.

Data management is an extremely important part of the wireless operator's business. Literally millions, if not billions, of bits of information available through modern database systems can easily become an inefficient bottleneck. There are large amounts of information generated at various points in the network. For example, call event detail records (call event records) are generated by the switching centers in a wireless network. Currently these records are primarily used for strictly billing purposes.

Communication service providers are increasingly lessening their dependency on single telecommunication equipment vendors. These providers often find themselves acquiring companies or being acquired. One outcome of these mergers is the possibility that call service providers are using telecommunications equipment from multiple vendors. Even call service providers that are not part of these mergers and acquisitions will probably have equipment for multiple vendors servicing various features of their system.

Call service providers (CSPs) need to access these systems to gather usage information that can be translated to billing data. Traditional call service providers develop their own interface to the telecom equipment and relay the required information to the billing system. As call service providers began to utilize telecom equipment from multiple vendors, developing and maintaining interfaces in each system became a huge task. Many CSPs have adopted an approach that utilizes mediation devices that are capable of capturing billing system data from multiple vendors simultaneously. These systems then feed the billing systems.

The information provided by a telecom switch is encapsulated in a call data record (CDR) and each switch manufacturer typically has a unique and proprietary format for its CDR. Mediation systems typically extract 5% of the available information in a CDR. This 5% is all that is required for billing systems.

As call service providers attempt to efficiently and quickly launch new services, they are becoming increasingly aware that CDR data can be of great value. In addition, existing customer care systems, fraud detection and other similar applications are finding the need for CDR data as well. Properly utilized, data can be the lifeblood of today's business. Far too many companies casually discard important information. In the telecommunications industry some call communication service providers discard 95% of the information generated about a call. This data can be critical in helping companies make strategic decisions to ensure they thrive in the marketplace.

Problems with handset devices used within cellular telephony systems may manifest themselves in a variety of fashions. These problems may be caused by a variety of reasons. A consumer typically has no idea of where a particular problem may lie and is generally inclined to believe the handset device is the source of the problem. In such cases, the handset device is generally returned for repairs. Once the handset device comes to the repair depot for repair or replacement, it is virtually impossible to reproduce the conditions under which the errors may have taken place and therefore it is very difficult to determine the causes of a problem. This makes the repair situation a much more complex process and includes all of the attendant costs involved with either making the repair or declaring the handset device to be irreparable. Carriers have previously been unable to view the true performance of a handset device within the network. Thus, some manner for enabling a carrier to proactively monitor the operation of handset devices on their network would prove a great benefit to the carrier.

### SUMMARY OF THE INVENTION

The present invention disclosed and claimed herein, in one aspect thereof comprises a system for tracking handset operations within a wireless network. The system includes an interface with a database that contains call data relating to handset operations. The handset operation call data within the database is collected from various call data records. An extraction module analyzes the call data within the database to obtain mobile originating call data and mobile terminating call data responsive to various designated filter conditions. A second database stores the mobile originating call data and mobile terminating call data extracted by the extraction module. A user interface enables a user to create the designated filter conditions and utilize the mobile originating call data and mobile terminating call data to provide at least one handset report describing operation of at least one handset.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates the functional components of the system;

FIG. 2 illustrates components of a data mart;

FIG. 3 is a block diagram of the physical components of the system;

FIG. 4 is a more detailed diagram of the operational components of the system;

FIG. 5 illustrates the operation of the mediation platform;

FIG. 6 illustrates the primary application processes within the mediation platform;

FIG. 7a illustrates the parser system;

FIG. 7b illustrates the process by which the enterprise engine within the parser processes call data records;

FIG. 8 illustrates the data repository;

FIG. 9 illustrates the data base and an instant layout of the data repository;

FIG. 10 illustrates various reports that may be requested;

FIG. 11 is a flow diagram illustrating the process by which event records are processed throughout the system;

FIG. 12 illustrates the state of the call data records throughout the system;

FIG. 13 is a block diagram of the device analysis system of the present disclosure;

FIG. 14 illustrates the model in TAC management screen provided by the device management system;

FIG. 15 illustrates the new model window provided by the device management system;

FIG. 16 illustrates the data entry pop-up box provided by the device management system;

FIG. 17 illustrates the TAC pop-up screen provided by the device management system;

FIG. 18 illustrates the TAC information window provided by the device management system;

FIG. 19 illustrates the handset top and bottom performers screen provided by the device management system;

FIG. 20 illustrates the handset performance details screen tabular view provided by the device management system;

FIG. 21 illustrates the handset performance details screen graphical view provided by the device management system;

FIG. 22 illustrates the Unique IMSI Counts screen provided by the device management system;

FIG. 23 illustrates the CDR query screen provided by the device management system; and

FIG. 24 illustrates the query results screen provided by the device management system.

### DETAILED DESCRIPTION OF THE INVENTION

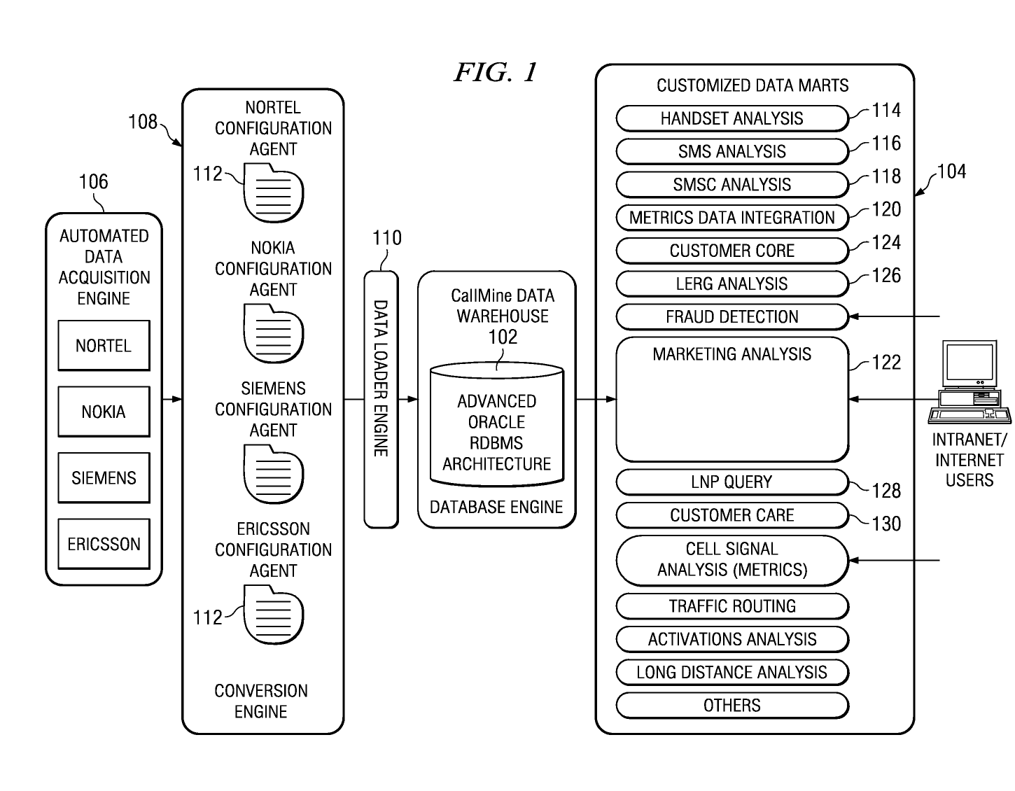

Referring now to the drawings, and more particularly to FIG. 1, which illustrates the functional components of the present system. The present system was developed to help communication service providers (CSPs) capture, process and utilize the information necessary in the operation of their business and to ensure informed business decisions. The system comprises a collection of configurable applications and processes that capture call data record (CDR) information. Call data records (CDRs) are generated at the mobile switching centers within the various communication service providers. CDRs contain data such as the time of a call, the duration of a call, unique identification numbers associated with a call, the service type used by the call and other useful information. Existing systems make limited use of CDRs to, for example, obtain billing information on a particular user. However, the vast majority of CDR data is not being expeditiously used by system providers. For a wireless network, the heart of the billing system is the call event detail record. A call event detail record can be generated for many different call types, including mobile originated, mobile terminated, short message services and many others. Call event records in wireless systems are usually initially generated by the mobile switching centers, but may also come from other elements of the network.

Each vendor who builds a switch uses a different approach to comply with industry specifications. In the call event records, some fields of data are designated as mandatory along with other fields for proprietary data. In addition, there are many optional data fields that are included. The basic purpose of call event records is to create billing information. Operators must add an additional layer in their system to convert the data coming from the different switches and to extract from that data that can be used to create the billing records. Many times data that does not directly relate to billing records is stripped and disregarded. In some instances, the differences in data format can lead to dropped information and the resulting loss of revenue.

There is a huge amount of detail available for each call (a typical Nokia mobile originated records, for example, contains over 400 characters of information). Some of the information available in call event records includes, but is not be limited to, date/time, calling number (subscriber identifier), called number, usage/duration of call, switch, cell identification, diagnostic information for dropped calls, handset type, the exact location of the caller, useful for value added services, trunk routing of calls, tariff data, call forwarding and voice mail information.

While the present description is provided with respect to the capture of CDR information, the capture of any call event data may be made using the system described herein. Thus, other types of information that are generated responsive to requests over wireless or wire line networks may be obtained using the system described herein. Once the data has been captured, it is converted and loaded into a database 102. Once the data has been loaded into the database 102, the system has a number of data marts 104 to analyze and present the information graphically to a user in an intuitive and meaningful way. Each data mart 104 is customized to allow the user to specify the information that is needed for each specific user whether they be managers, executives or engineers.

The system illustrated with respect to FIG. 1 provides the following basic functionalities. The system interprets the various formats of the call data records returned by different data sources communication with an automated data acquisition engine 106. A conversion engine 108 enables system to be fully configurable to work with a variety of different data transfer protocols. The data loader engine 110 pushes the data to the system to allow for maximum capability with existing systems. The database 102 is a redundant and scalable Oracle based database providing a strong foundation for future expansion and maximum up time and manageability. The multiple data marts 104 support ad hoc queries on database elements.

The data collection engine 106 establishes a link between the server and a mobile switching center. This link can be over a variety of different transfer protocols and is fully configurable depending upon each unique setup of the communication service provider. A mobile switching center (MSC) is configured to push or send data to the system where the conversion engine 108 will process the records. The system has been engineered to work with complex networking and security protocols that allow it to work with most external call service providers. The CDR data is acquired in a manner that does not impact the company's billing process.

Once the data has been acquired from the mobile switching center, it is stored in a temporary location. Different switches on the market may use different transfer protocols for communication, or record CDRs in different formats. These differences are compensated for in the collection process. The collection can be done at predefined intervals or at other times as dictated by the needs of the communication service provider.

The data conversion engine 108 is the second portion of the system. This component is where differences in CDR format are alleviated. The data conversion engine 108 is designed to be as flexible as possible. The data conversion engine 108 is java based allowing for this flexibility. As noted above, different mobile switching centers may use different proprietary formats. The java based engine takes these differences into account. For each type of record, there is a corresponding configuration mode that engine 108 can use to convert records. Without this, the data would be passed to the core database 102 in a non-usable fashion.

After CDRs have reached the temporary storage location within the system, the conversion engine 108 reads these records. In its original format, a CDR may be in composite binary or hexadecimal form. However, this can change for each switch type. The data conversion engine 108 converts these raw composite records into a standard ASCII format, which is then written to disc. After the initial conversion, the conversion engine 108 groups all calls based upon the call type. For example, all cellular mobile originated calls are grouped together in one group, and another file is written to the disc. At this point, the data is ready to be loaded into the core database 102. The data loader engine 110 loads the converted data from the conversion engine 112 into the database engine containing the database 102.

Many communication service providers are capable of generating large amounts of data, possibly millions of records each day. A stable platform must be available to accept such a large amount of information. The database 102 accepts any number of non-switch based data feeds from various business systems. The database 102 allows for correlation of switch data with business systems data providing powerful analysis and business decision systems capabilities.

The data marts 104 enable the specific needs of a communication service provider to be met once switch information has been processed and stored. Business customers may require many different views of the information contained in the database. The system performs validation, parsing and customer specific filtering on information it receives from the switch and sends only the relevant information to the required data mart 104. This approach ensures that contention for data is minimized and that the performance characteristics of the system are retained. The customer is not required to wade through data that is not relevant to their needs.

The data marts 104 are customized for the needs of each communication service provider. Customers are able to determine specific data sets, which are required for analysis. Customers also define requirements for reporting and access. Each data mart 104 may consist of four main components: user defined data set, graphical user interface (GUI), administrative tools, and user defined reports. This type of configuration has been chosen to ensure that the system is as intuitive as possible for the end user. By using these different components, the individual aspects of each data mart 104 can be configured.

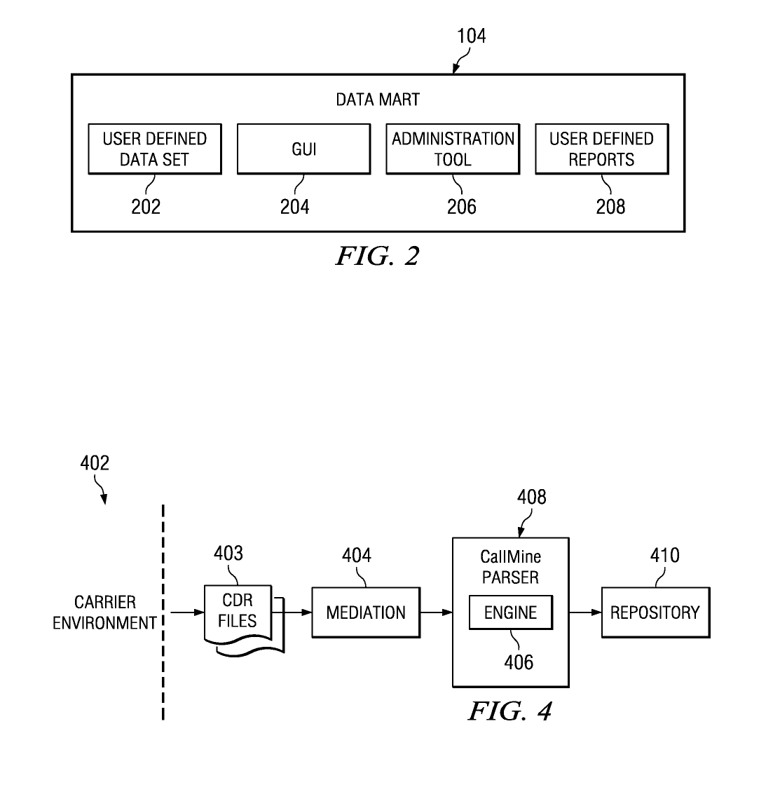

Referring now to FIG. 2, there is more fully illustrated the various components of the data mart 104. Within the user defined data set 202, the users determine data elements appropriate for their analysis requirements. These specific data elements are replicated from the core data warehouse 102 into specific data marts 104. This ensures queries against the data do not contend with queries from other data marts 104. The graphical user interface 204 is a web enabled GUI delivered as part of each data mart 104. The GUI 204 allows a user to log in and query the information in a particular data mart 104. The GUI 204 may be customized to meet module owners' various needs. The administrative tool 206 allows administrators to add users to a data mart and control their access levels. The administrative tool 206 also allows the administrators to modify data elements being replicated from the data warehouse 102 to the data mart 104. The user defined reports 208 provide a variety of reporting options to the user. Some of these include canned reports, internet web publishing, various file and database exports. The system supports COGNOS, Business Objects and other off the shelf end user reporting tools for database reporting purposes. Customized data marts 104 may also be made available for the communication service provider. These other type of data marts 104 can be rapidly deployed and integrated into the system. The system supports ad hoc queries to help provide the most up-to-date or flexible information available about the system.

Referring now back to FIG. 1, examples of various data marts 104 are as follows. A handset analysis data mart 114 is an application providing advanced tools for performing handset analysis and data pertaining to uses and performance. The data marts analyze and present the information graphically to a user in an intuitive and meaningful way. Communication service providers often have to rely on subscriber care data, which may not be complete and it may be days old, even weeks old when it is received. The handset analysis data mart 114 allows the timely retrieval of CDR data which will provide critical information such as identification of handsets that are abnormally dropping calls on a regular basis and handsets that are causing unwanted network traffic.

The SMS/SMSC analysis data marts 116 and 118 are other types of applications. Many communication service providers use SMS (short message service) and SMSC (short message service centers). Each time a text message is sent through the SMSC system, a CDR is created. Many communication service providers use the SMSC as a delivery mechanism for special applications such as ring tones. Using these data marts 116 and 118, communication service providers will be able to track usage of the SMSCs sending regular text messages, downloading ring tones and other patterns. This data can be used to drill down to specific application uses. In the case of downloading ring tones, a record could be sent to billing each time a ring tone is downloaded. This will eliminate the need for sending credit card information over the Internet and would streamline the process.

The metric data integration data mart 120 is an application that gathers information about signal towers. The data mart 120 measures the signal density around the tower and provides summary statistical data about the cell. This data being summary in nature is useful, but when the data is combined with CDR data it becomes a powerful tool. With the CDR data, communication service providers can get IMEI and MISDN for the calls that are being abnormally dropped along with who dropped the calls and when the calls were dropped. Integrating this with the metric data will provide critical information in determining utilization of a cell and future placement of the cell site.

The marketing-usage analysis data mart 122 provides an application for communication service providers to calculate minutes of use for any given day or time period, from data only hours old. This will give communication service providers a way to track usage of special services or promotions and the ability to target specific marketing groups.

The customer care usage analysis data mart 124 allows data from the CDRs to enable the communication service providers to track how many abnormally terminated calls are happening for a subscriber and what handset is being used. This enhances trouble shooting uncovers possible problems with handsets and provides an up-to-date tracking of minutes of use on a subscriber's plan.

The NPA/NXXX data analysis data mart 126 uses the LERG (local exchange routing guide) which is a master directory of all phone numbers in the U.S. and the carrier to which they are assigned. By correlating the LERG data with CDR data, communication service providers have a tool for reporting which numbers are active on any given switch/market. The data mart 126 also provides a comprehensive analysis and reporting to satisfy FCC directives to have new regions assigned.

The LNP (local number portability) query data mart enables information related to local number portability queries. The FCC has mandated that wireless carriers provide subscribers with LNP numbers. Each wireless number is assigned an additional tracking number managed and maintained in the national database. Communication service providers can query this database to determine the current status of wireless numbers, but there will be a cost for this transaction. With the correlation of CDR and LERG data, communication service providers are able to track usage for numbers assigned to them. The LNP tracking number can be stored for all numbers within the data mart 128 that port to different carriers. This enables reporting and analysis and greatly decreases the need for querying the national database.

The customer care data mart 130 provides the ability to utilize CDR data with hours or give communication service providers the timely data needed to identify and predict fraud. This data will give communication service providers the ability to analyze the call behavior of subscribers who default on their first payment, usage patterns of first billing periods, the ability to take predictive action on accounts that have reached extreme accumulation levels and provide detailed analysis of these accounts.

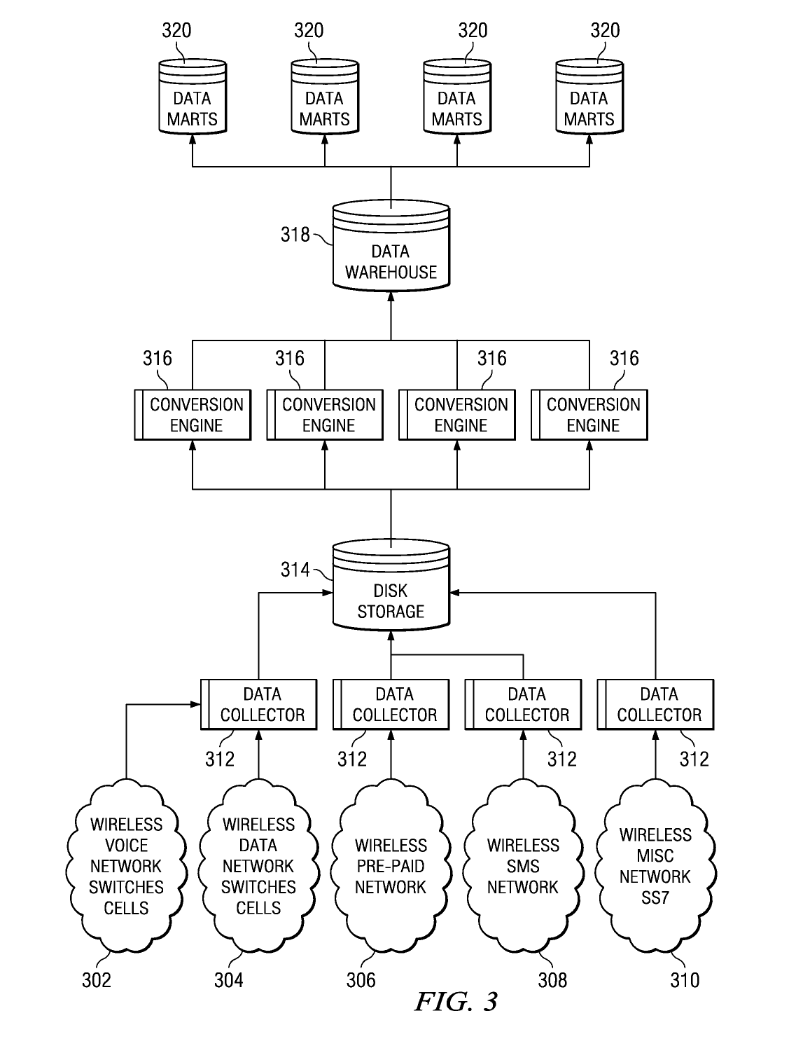

Referring now to FIG. 3, there is illustrated a block diagram of the physical components implemented within the system of the present invention. The overall system is connected with a number of call service provider functionalities. The communication service provider functionalities include wireless voice network switching cells 302 providing cellular voice services using GSM, TDMA, 3G, etc., protocols; wireless data network switching cells 304 providing wireless data transmission services to various users; wireless prepaid networks 306 providing prepaid wireless telecommunication services to various users; wireless SMS networks 308 providing wireless short message services to users and wireless miscellaneous networks 310. Each of these wireless networks are connected to various data collectors 312 that extract the information from each of the associated networks in the form of call data records or other type of call event records that provide information concerning a particular connection established by a user to transmit data of any type, such as voice data, video data, etc. The extracted data is temporarily stored within a disc storage area 314 once extracted from the various records provided to the data collectors 312.

Once the data has been temporarily stored within the disc storage 314, various call conversion engines 316 are responsible for converting the temporarily stored data within the disc storage 314 into a format which may be analyzed further by the system. The data is converted into an ASCII format and then stored within the general data warehouse database 318 containing all of the data extracted from the various networks and cells. The data within the data warehouse 318 has been parsed and analyzed to provide various relevant data to each of the established data mart applications 320. The data mart applications 320 may use the data for various needs with respect to a network such as engineering, finance, customer care, marketing, management or operations. The data marts 320 may be individually configured to provide any desired application based upon a customer's needs.

Referring now to FIG. 4, there is illustrated a more detailed block diagram of the operational components of the system. Information from the wireless network environment 402 is provided to a system mediation platform 404 in the form of a CDR or other event files. The mediation platform 404 provides for storage and tracking of CDRs or other event records until they are requested by the engine 406 within the parser 408. The mediation platform 404 performs the functions of the data collector 312 described previously with respect to FIG. 3. The mediation platform 404 receives event records pushed from multiple switches operated by a wireless carrier. If the carrier has service agreements with other wireless carriers, it may accept and process event records originated from switches operated by the other carrier. The event records have been stored in the mediation platform 404. The mediation platform 404 sends messages to the enterprise engine. These messages contain news of new events records that are ready for downloading. Once the enterprise 406 engine receives a message, the engine 406 provides a message back to the mediation platform 404. This message provides relevant information (e.g. path and file name information) to a Java based download server process, which then pulls the new event records from the mediation platform 404 via a Java message service (JMS)/file transport protocol (FTP).

The parser 408 performs the data conversion engine functionalities 316 described previously with respect to FIG. 3. Once acquired, the event records are parsed within the enterprise engine 406. In other words, data of interest is extracted from the event record file via an XML enabled Java process. The data of interest is bulk inserted into the data repository 410 by a Java database connectivity process (JDBC). Data that originates in the event record which can be extracted to the data repository 410, may include, but is not limited to, the calling/called number, calling/called equipment, time stamps, type of radio channel, dialed digits, trunk routing, location, call duration, fault codes and recording switch information. The enterprise engine 406 has the ability to extract multiple streams of data and send it to multiple data repositories 410. However, for the present example, only one data repository 410 is illustrated.

Once the data has been converted within the parser 408 and divided into appropriate groupings, the data is stored within the repository database 410. The repository database 410 stores all of the data extracted from the provided CDR files 403 such that the information may be used by various data marts 320. The data repository 410 is the primary database of information. The database in the data repository 410 is queried by numerous extract, transform and load (ETL) processes. These processes are built with SQL/PL language. Each of these ETL processes are used to populate the various data marts.

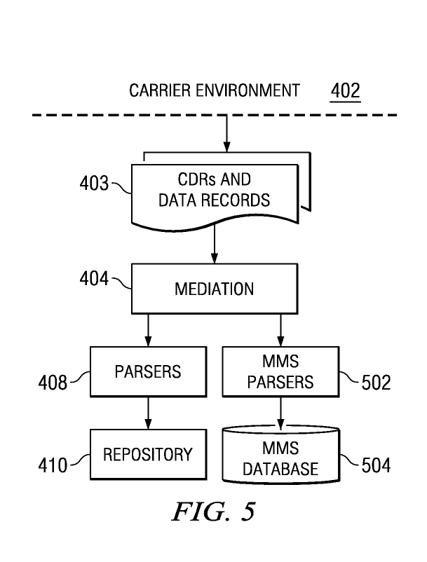

Referring now to FIG. 5, there is more fully illustrated the operation of the mediation platform 404. The mediation platform 404 is configured to interface with call service provider mediation services to actively receive files containing event detail records from various network sources including CDRs and GPRSs (General Packet Radio Services). The mediation platform 404 receives files of event detail records and manages the distribution of the files to the parser 408 and the MMS parsers 502. The mediation platform 404 provides for the distribution of CDR files to the parser 408 to support the repository database 410 and to a multimedia device discovery service parser 502 which provides real time support for MMS services on a communication service provider network. The MMS parser 502 receives continuous feeds of CDR files from the mediation platform 404. The MMS parser parses the data and for each MOC and MTC extracts the MSISDN and IMEI information. The IMEI information is used to look up the specific MMS capability of the device in the MMS database 504. If the MSISDN and IMEI represent an unknown subscriber with an MMS enabled phone, or a known subscriber changing MMS capability, the MMS parser 502 will communicate with MMS or other servers to update them if necessary.

Currently, call data records enter the mediation platform 404 from a mediation system. The mediation platform is provided by the mediation platform 404 a third party provider which collects CDR records from the various mobile switching centers within a communication service provider network and sends these records to various destinations such as the billing system. CDRs are pushed from the mediation platform 404 via file transfer protocol (FTP) to the active node of the mediation platform 404. The mediation platform 404 provides storage and tracking of the CDRs until they are requested by the parser 408 or the MMS parser 502. CDRs are stored on the mediation platform until their specific retention window is exceeded. GPRS records and data records enter the mediation platform 404 from the carrier mediation system, but are not distributed to the parser 408 for processing. The parser 408 provides the parsed data to the repository database 410. The MMS parser 502 provides the parsed information to a MMS database 504.

In one example, the mediation platform 404 operates on a two node cluster of Sun V65X servers running Red Hat AS2.1 and a Merodis cluster server. The cluster is run in an active stand-by configuration with the active node referenced by a virtual IP (VIP) address. Incoming voice records are received from three machines via FTP and from a single VIP via SFPT 4. Files are pulled via FTP from the mediation platform 404 by the parser 408 and DDS parser 502.

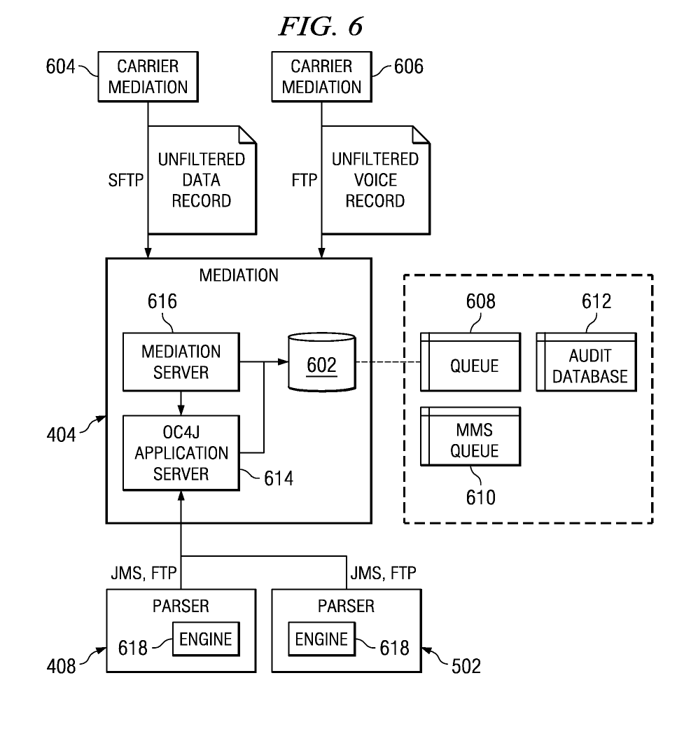

Referring now to FIG. 6, there is illustrated all of the primary application processes involved with the mediation platform 404 as well as the significant data structures used to support the applications. The mediation database 602 stores information about files it receives from the Carrier Mediation 604 and Carrier Mediation 606 systems. As described previously, the Carrier Mediation system 606 provides voice records to the mediation platform 404 and the Carrier Mediation system 604 provides data records to the mediation platform 404. An Oracle advance queuing object (a queue) supports Java message service (JMS) and manages feed processing within the mediation platform 404. Mediation database 602 stores information about files received from each switch. These files are subsequently queued for parsing and feeding into downstream parsers 410 and MMS parsers 502. The database 602 stores various data queues for the downstream systems. A parser queue 608 queues information to be transmitted to the parser engine 410. The MMS queue 610 stores information queued for the MMS parser 502. An audit database 612 stores audit information for the repository database 410 CDR records. The MMS database 504 automatically provisions features for equipment as calls are detected on a switch.

The application server 614 serves as the point of contact for the applications accessing the respective queues from the parser 408, and acts as a conduit for updates to the audit database 612 after processing is complete. The application server 614 is also used to host the mediation management web application. The mediation process depends on the Oracle application server containers for J2EE 10g, also known as OGC4J 9.0.4. This is a requirement of the Oracle JMS provider.

The mediation server 616 is responsible for identifying and in queuing all incoming files from configured switches/locations. Event files are sent to specific applications based on their switch location. For example, all CDR files from a particular MSC may be sent to both parser engine 408 and MMS parser 502 applications. In addition to queuing files for processing by configured applications, the mediation server 616 updates the audit database 612 to store metadata about incoming files and the applications to which they will be delivered. The applications for implementing the data mining services within the parser 408 and the MMS parser 502 comprises the enterprise engine 618 which is responsible for organizing and extracting necessary data for storage within the repository database 410.

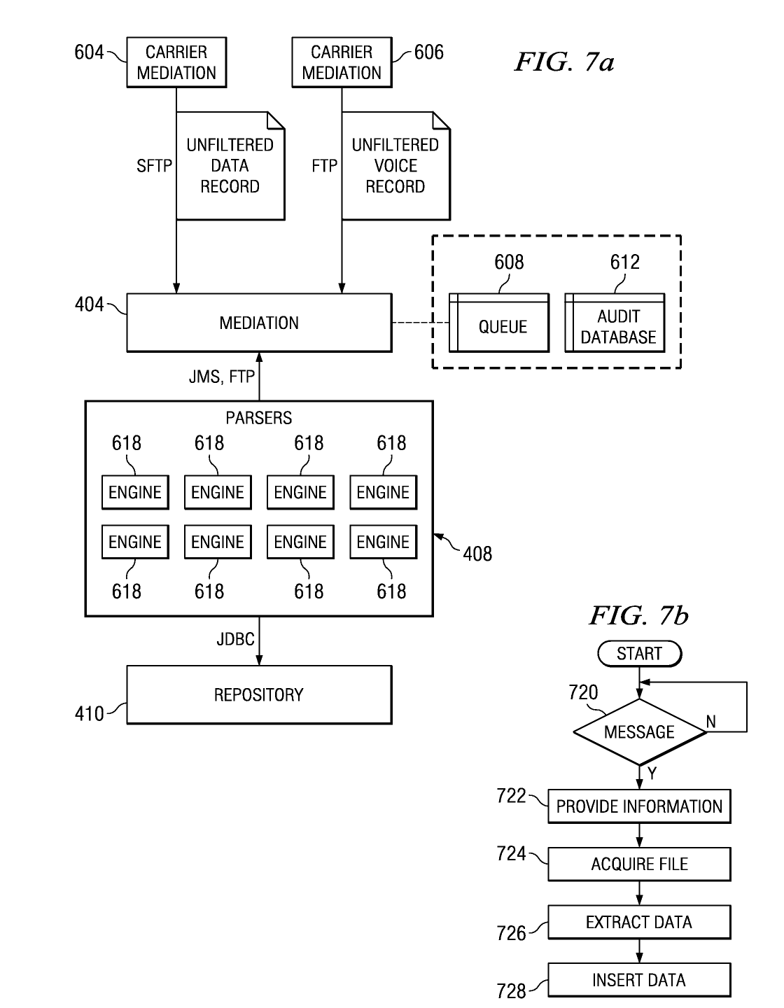

Referring now to FIG. 7a, there is more fully illustrated the implementation of the parser system 408 in the overall system. The parser 408 is configured to interface with the mediation platform 404 and the data repository 410. The parser 408 is comprised of a number of enterprise engine 618 instances all working in parallel to pull CDR files from the mediation platform 404, parse the data and store data records in the data repository 410. Each enterprise engine 618 is configured to parse and output a given set of records for vendors and versions in a specified format. The feed/queue used by the parser system 408 to populate the data repository 410 is independent of the feed from the mediation platform 404 to any other systems.

Referring now to FIG. 7b, there is illustrated the process by which the enterprise engine 618 within the parser 408 processes call data records received from the mediation platform 404. The enterprise engine 618 listens at inquiry step 720 for messages from the mediation platform 404. The messages contain news of a new CDR file that is ready for downloading from the mediation platform 404 to the parser 408. When the parser 408 detects this message, it provides at step 722 relevant information to a Java based download server process. The relevant information comprises, for example, the path and file name information. The Java based download server acquires at step 724 the new CDR file from the mediation platform 404 via a Java message service (JMS/FTP pull). Once the CDR file has been acquired, it may be parsed. The parsing process involves data of interest being extracted at step 726 from the CDR file via an XML enabled Java process (a parser). The data of interest is then bulk inserted at step 728 into the data repository 410 by a Java process via Java database connectivity (JDBC).

Currently, call data records enter the mediation platform 404 from the mediation system 606. The mediation system 606 is provided by a third party provider which collects files of CDR records from various mobile switching centers within communication service provider and sends these records to various destinations, such as billing systems. CDRs are pushed from the mediation system 606 via file transfer protocol to the active node of the mediation platform cluster. The mediation platform 404 provides storage and tracking for files of CDRs until they are requested by the enterprise engine 618 instances running on the parser 408. Additionally, CDR files are stored on the parser 408 until their specified retention window is reached.

The parser 408 operates on multiple hardware platforms. Messaging to the mediation platform 404 is done via the Java message application program interface and files are transferred from the mediation platform 404 via FTP pull. Enterprise engine instances 618 insert parsed CDR data into the data repository 410 using the JDBC Java database connectivity application program interface. The parser system 408 contains some redundant CDR storage for those nodes currently being processed into the data repository 410. This storage overlaps with the larger retention window stored on the mediation platform 404.

FIG. 7a illustrates all of the primary application processes comprising the parser 408. Arrows represent the direction of API calls and not data flow. The enterprise engine 618 is an RMI (remote method invocation) based server. The first enterprise engine instance 618 started on the server also starts two shared resources not shown above which are the RMI registry and the log server. The RMI registry is a required component, while the log server is not required unless log files are needed.

The data repository 410 receives data records from the parser system 408. The data repository 410 is the source of information for the data marts and the user interface. The data marts feed information to an server for delivery to systems that internal to a customer. The data repository 410 is required for the parser systems 408 to function without error. The data repository 410 is the data source for the data marts. If the data repository 410 is brought down, the data marts will continue to function.

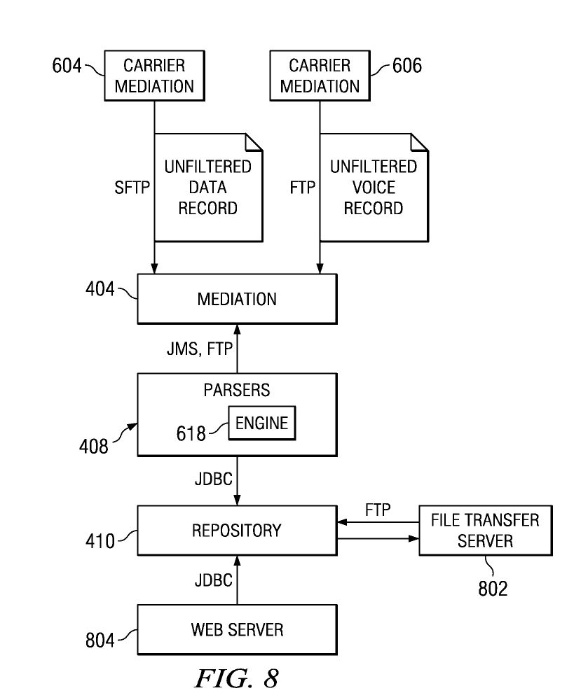

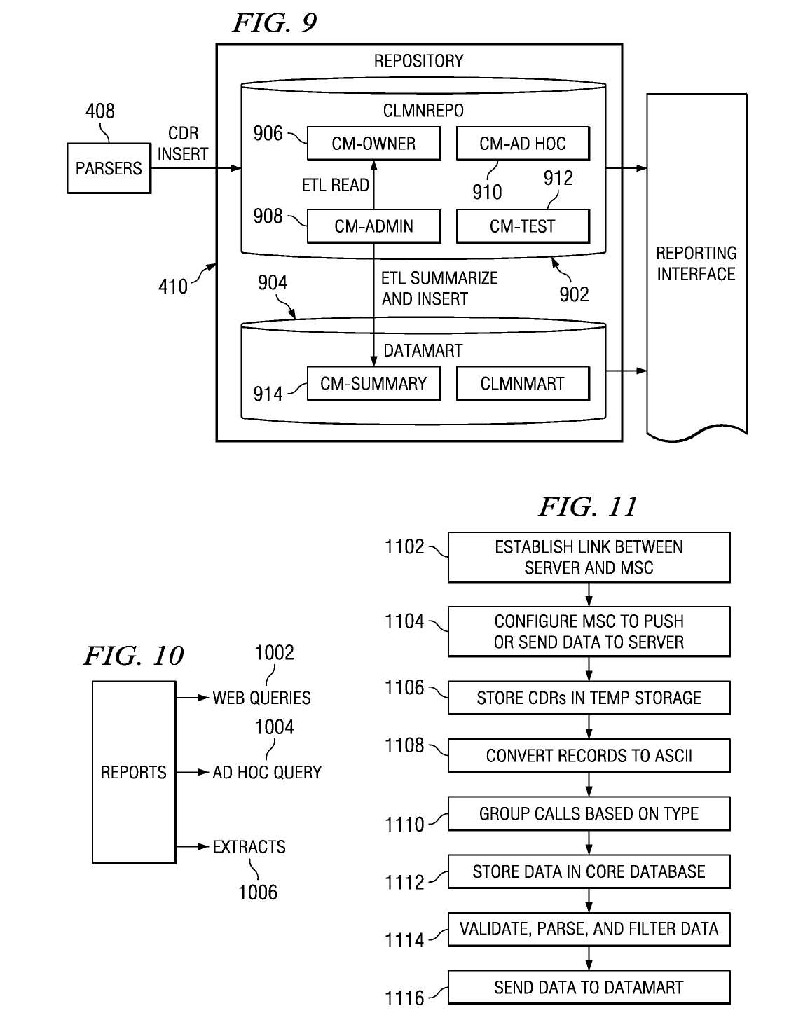

Referring now to FIGS. 8 and 9, there is provided an illustration of the database and instance layout for the data repository 410. The data repository 410 is a data store of information on the interactions between wireless subscribers and a carrier network. The data repository 410 consists of a database storing call records (CDRs) processed by the enterprise engine 618, and the processes used to summarize that information for consumers in other application processes as well as associated metadata. The data repository 410 operates on multiple hardware platforms. The data repository 410 is accessed by remote systems to populate raw data via Java database connectivity (JDBC), and to access summarized data via GDBC. Extra files generated through ETL processes are both pulled and pushed via FTP to the file transfer server 802. The data repository 410 includes two databases CLMNREPO 902 and CLMNMART 904. The CLMNREPO database 902 is the repository for all call data records received from the parser 408. The CLMNMART database 904 contains summary data that has been processed by extract, transform and load processes. The CLMNMART database 904 also contains reference data for other system applications. The CLMNREPO database 902 organizes records by switch, vendor and vendor version and call type. The data is partitioned by date. The following types of data may be stored. Data such as MOC (mobile originated call), MTC (mobile terminated call), SMSO (Short Message System Originating).

The collection of database objects stored within the CLMNREPO 902 are owned by a particular user and referred to as the user's schema. Since automated processes populate the CLMNREPO database 902 and the CLMNMART database 904 on most reporting data accesses through the web interface 804, few individual user accounts exist in the data repository 410. The user CM-owner 906 indicate the owner of tables, table partitions, indexes and index partitions containing call data record data. Other schemas contain synonyms that point to CM_owner tables. The user CM_admin 908 indicates the owner of extract, transform and load code. Synonyms point to the CM_owners tables. Synonyms point to a reference data in the CM_summary schema in CLMNMART database 504 described hereinbelow. The usage contains errors from ETL processing and daily and hourly record accounts. Errors in record accounts are viewed during daily system monitoring. User CM_adhoc 910 indicates user database structures that facilitate delivery of special requests by network customers. Structures are temporary in nature and stored for weeks or months. Structures store data formulated according to specific requirements. CM_test users 912 are users of the quality assurance group to view call data records. It contains synonyms pointing to all CM_owner tables. The users of the CLMNART table include CM_summary users. The CM_summary schema 914 owns all reference tables and summarize data for the application system. PERFSTAT users 916 own oracle performance monitoring objects and record performance statistics on an hourly basis.

Referring now to FIG. 10, The customer has access to predefined reports through a web interface 804. Connectivity to the web interface is required to make Web queries 1002. The user interface display varies depending on the products purchased by the customer. Additional data can be accessed through a series of drill down menus. Customers receive reports through three different mechanisms. The call line portal displays reports based on the products purchased by the customer. The customer can also request specific ad hoc reports 1004. Lastly, the customer receives daily and weekly scheduled extracts 1006 based on their predefined requirement. Customers frequently request ad hoc reports. The ad hoc requests are oracle, SQL or PL/SQL scripts and can run at any time. Extracts 1006 provide the customer with summarized data based on detailed requirements. The extracts 1006 run on a predetermined schedule.

Referring now to FIG. 11, there is illustrated a flow diagram describing the process by which event records received from communication service providers may be utilized by the described system. Initially, a link is established between the system server and a mobile switching center within an external network at step 1102. The server includes the mediation platform 404 described herein above. Next, the MSC on the provider network is configured to push or send data to the server at step 1104. This will enable the communications service provider network to provide the various call event records to the system. Next, any received call data records are stored at step 1106 within a temporary storage area of the mediation platform 404. The stored CDRs are then converted to an ASCII format at step 1108. The converted call data records are then grouped at step 1110 based upon the type of call or data record from which the converted record was created. The data may then be validated, parsed and filtered at step 1111 to place the data in a usable format for various data mart operations that have been established for use by different customers. The group data is then stored within the core database of the data repository at step 1112. The data may then be further filtered at step 1114 to extract data required by a particular data mart. The validated, parsed and filtered data is sent at step 1116 to the data mart such that the information may be utilized.

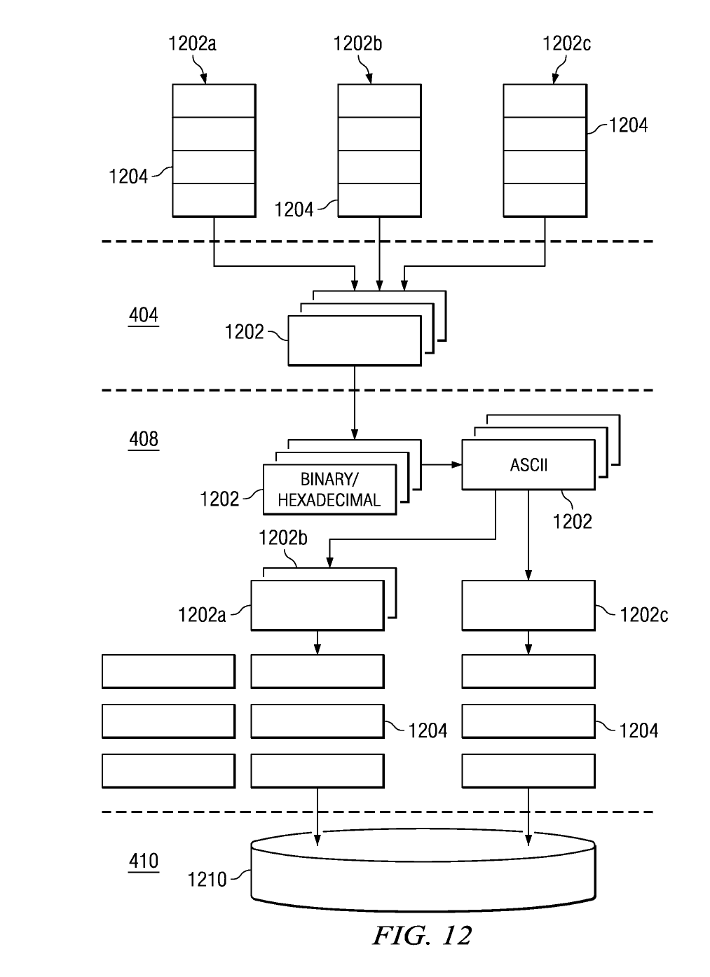

Referring now to FIG. 12, there is illustrated the manner in which various call data records are transmitted between the mediation platform 404, parser 408 and data repository 410 and the manner the data records are processed within these various system components. Initially, call data records 1202 are downloaded from various call service providers to the mediation platform 404 via a file transfer protocol (FTP) push or pull. At this point, the call data records 1202 contain various pieces of data 1204 which may be utilized. The call data records 1202 are stored temporarily within the mediation platform 404. They are stored within a database in the mediation platform 404 and at this point the call data records 1202 are within a binary or hexadecimal format depending upon the format utilized by the switch from which the CDR within the call service provider was transmitted. The call data records 1202 also contain all of the data originally included within the call data records 1202 when transmitted from the CSPs.

The call data records 1202 are then transmitted to from the mediation platform 404 to the parser 408. This transfer occurs using either a Java message service (JMS) or file transfer protocol (FTP). Once the CDRs 1202 are received at the parser 408, the format of the CDRs 1202 are converted from the original binary/hexadecimal format into an ASCII format. The ASCII converted CDRs 1202 are then grouped according to the type of switch from which the CDRs 1202 came. Thus, if CDRs 1202a and 1202b came from the same type of switch within the call service provider's network, they would be grouped together as shown. CDR 1202c being from a different type of switch is grouped by itself as illustrated in FIG. 12. However, in practice this CDR 1202 would be grouped with like CDRs 1202 from similar type switches. After the CDRs 1202 have been so grouped, the data within the CDRs may be parsed via an XML enabled Java process 1206. During this process, data of interest is extracted from the call data record such that the data is usable by the data marts for performing analysis on the system. The parsed data is then stored within a database 1210 within the data repository 410. The parsed data within the database 1210 may then be utilized by various customer created data marts to perform any desired type of analysis. Thus, the provided call data records 1202 were processed in a manner such that the individual data contained within these call data records was extracted and placed within a format that was usable for system analysis.

The information within the data repository 410 may be utilized for providing a number of end user services. For example, a network service provider may be provided with the ability to proactively monitor handset device operations within their network. The ability to monitor handset device performance over the network would provide a number of advantages to the network service provider. The network service provider would be able to reduce the cost of repairing handset devices by providing relevant information about the problems that a handset device encounters while in use at a consumer location. This information may be made available at a point of use for a particular handset device when information is needed to effect a repair or diagnosis of a problem with the handset. Handset device performance information may also be used to increase subscriber satisfaction with the carrier network by improving services provided.

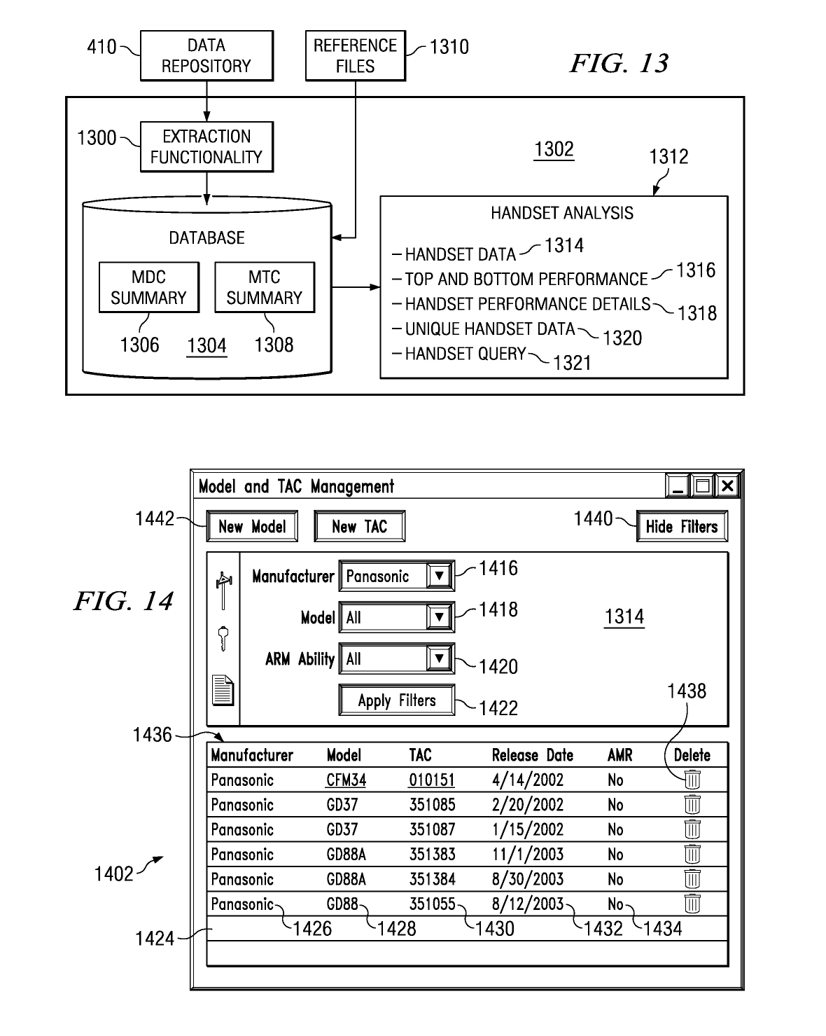

Referring now to FIG. 13, there is illustrated the use of a device management system 1302 which may be used in conjunction with the information contained within the database repository 410 in order to provide tracking of handset device operations within a wireless telephone network. The data repository 410 provides the core of the mined CDR information and describes activity occurring over the wireless network. The device management system 1302 utilizes the data contained within the data repository 410 to provide a wireless carrier with various reports on how a particular handset device may impact a customer's experience. The device management system 1302 is designed to support the analysis of call traffic to, from and between switches (MSCs) within a geographic market and between the MSCs and handset devices. The device management system 1302 uses data contained within mobile originating calls (MOCs) and mobile terminating calls (MTCs) traffic to analyze handset performance. The data is extracted from within the call data record information generated by the switches and stored within the data repository 410 by the extraction functionality 1303.

The incoming MTC analysis assists in the understanding of MSC traffic which can be a significant performance factor in markets with multiple MSCs. This analysis provides a view of where calls are actually terminating within a network or which devices are having call terminations. This data provides an understanding of the geographic dispersion of subscribers within a particular area. The outgoing call traffic (MOC) analysis provides a view of where calls are originating within the geographic area. The basic foundation for an analysis, the distribution of calls to destination NPA-NXXs is included within the device management system 1302. The information provided by the device management system 1302 can be used to optimize traffic within the service provider environment. The device management system 1302 provides a method to identify handset devices that may be causing problems and gather the required level of detail to support investigation and resolution with respect to particular devices using a handset analysis functionality 1312. The system gathers the information from the MOC and MTC traffic and summarizes the data by device (TAC) and by termination cause.

The information extracted by the extraction functionality 1303 of the device management system 1302 from the data repository 410 is provided to a database 1304 containing a summary of the mobile originating call data 1306 and the mobile terminating call data 1308. This information may be broken down with respect to the particular types of handset devices and for individual handset devices using the handset analysis functionality 1312. Reference files 1310 within the call service provider can provide base station controller and circuit information relevant to the switch connections within the call service provider.

The handset analysis functionality 1312 provides a number of different reports that are designed to help identify routing or traffic issues with respect to individual handsets and groups of handsets and to assist in the process of load balancing a network. The handset analysis functionality 1312 provides update capabilities to the reference tables 1310. Current handset device information accessed from the handset analysis functionality 1312 from the database 1304 provides the foundation for handset analysis within the system environment. The handset analysis functionality 1312 provides a user with a filter box function 1314 to identify the manufacturer, model and AMR (adaptive multi-rate) capability information to be processed in a data extraction operation.

The handset analysis functionality 1312 provides a historical view of how handsets have performed in relation to specific error conditions or within particular areas. The customer may obtain or provide data using the handset data functionality 1314, a Top and Bottom Performance functionality 1316, a handset performance details functionality 1318, Unique Handset Data functionality 1320 and a Handset Query Functionality 1321. The later three functionalities provide graphs that display historical performance of handsets as will be described hereinbelow.

The handset data functionality 1314 enables a user to look up information on various handset types based upon manufacturer and other criteria. Additionally, the handset data functionality 1314 enables the entry of new handset information or the updating of existing handset information by the user.

The top and bottom performance functionality 1316 provides a graphical and tabular representation of the top and bottom performing handsets based upon call terminations. This information would allow a user to quickly determine the best and worst performing handsets in a particular area or according to particular filter criteria established by the user.

The handset performance details functionality 1318 reports include error codes defined by the system that should be used to filter the extracted CDR per filter box designation. The information, including call count and minutes associated with the error codes, and the termination percentage, are displayed in spread sheet and graphical format. For the graphical format, the information is displayed by product release date, with the oldest to newest being displayed from left to right. The x axis has a label or grading scheme for the age of the handset. The y axis includes the termination rate for the error codes included on the report.

The unique handset data display functionality 1320 provides the customer a view of the number of unique users on a per handset basis. This is a summation of the unique users within a specific MSC or on a higher level within the network. The report for each handset will be displayed in a spreadsheet and graphical format. For the graphical format, the information is displayed by product release dates, with the oldest to newest being displayed from left to right. The x axis has a label or grading scheme for the age of the handset. The y axis will be the unique IMSI count included on the report.

The handset query functionality 1321 enables a user to generate a query on a particular handset device within a particular area and obtain query results based upon this query. The query results will provide detailed information on the operation of a particular handset within the defined area and assist in situations such as trouble shooting with respect to determining whether or not a particular handset is malfunctioning.

Referring now to FIG. 14, there is illustrated the model and TAC management screen 1402 including a filter box 1314 provided by the handset data functionality 1314. The filter box 1314 enables a user to select the particular types of handset data that are desired to be viewed. The filter box 1314 includes the manufacturer field 1316 for selecting a manufacturer of a handset device. The model field 1418 includes a drop down list for selecting the models of handsets associated with a selected manufacturer. The ARM ABILITY field 1420 enables selection of the adaptive multi-rate capability of the displayed handsets. The adaptive multi-rate is a technology used to provide special spectral efficiency, permitting the broadcast of more calls per base station. By clicking on the Apply Filters button 1422, the handset data functionality 1314 will extract the relevant information indicated by the filters from the database 1304.

The results window 1424 includes a listing of the handset devices extracted from the database 1304 responsive to the applied filters of the filter box 1314. The results window 1424 displays the resulting handset information and provides the capability to view a list of handsets in order to review relevant model information. The manufacturer column 1426 provides a listing of the manufacturers associated with particular handsets. The model field 1428 provides a listing of the particular models obtained from the search results. The TAC column 1430 provides a column listing the type approval code (TAC) for the handset. The TAC comprises the first six digits of the international mobile equipment identity (IMEI) number. The TAC identifies a unique version of the handset model. The release date column 1432 provides the release date of the associated handset, and the AMR column 1434 provides an indication of whether or not the handset has AMR capabilities. Particular results may be deleted from the search in the delete column 1436 by clicking on an associated delete button 1438. A hide filters button 1440 enables the filter box 1314 to be hidden to provide a larger screen for the results window 1424.

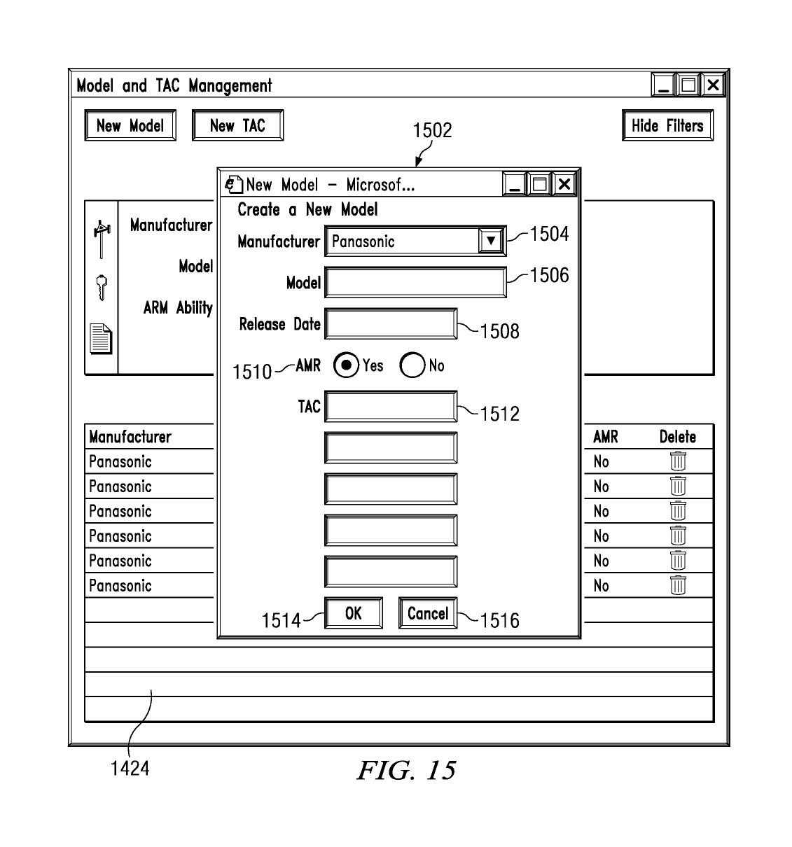

There are two methods for entering new model information into the handset information database through the handset data functionality 1314. The first is by clicking on the new models button 1442. This causes the new model window 1502 to appear as illustrated in FIG. 15. The new model window 1502 includes all of the fields necessary for entering new model information with respect to a particular handset. The manufacturer field 1504 enables entry of the handset manufacturer. The model field 1506 enables the model number of the handset to be entered, and the release date field 1508 enables entry of the month, date and year of release of the handset. The AMR field 1510 enables an indication of whether or not the handset has AMR capabilities, and various TAC identifiers associated with the handset may be entered in the TAC fields 1512. Once all of this data has been entered, the data is saved by clicking on the OK button 1542. Alternatively, the user may cancel the entry by clicking the Cancel button 1516.

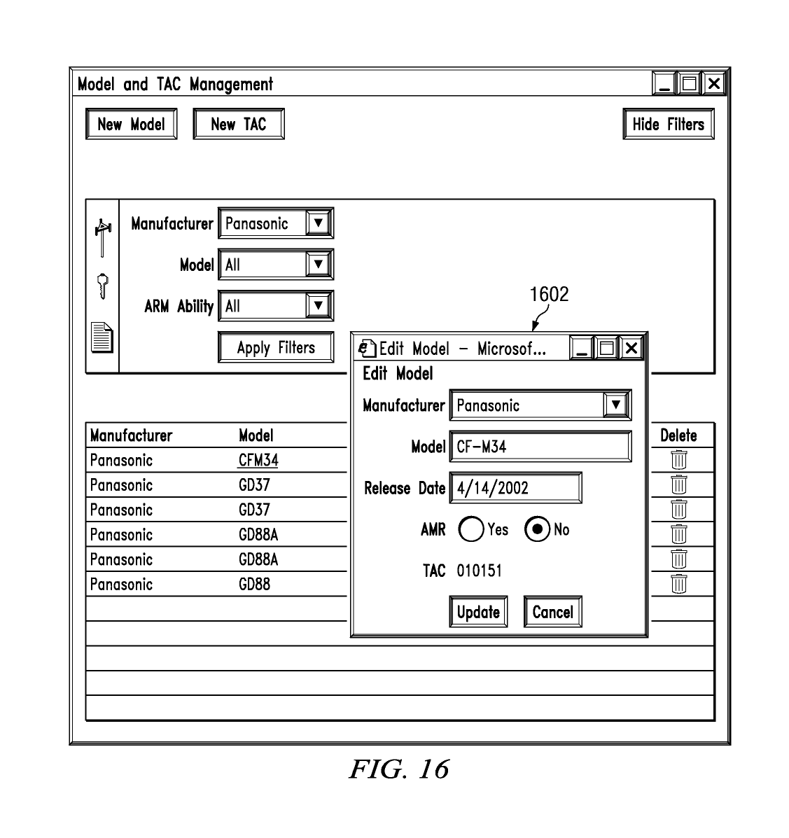

If an existing handset model requires information about the handset to be updated, the user may simply click on the model name within the display screen 1424 in order to update the information. A data entry pop-up box 1602 for that model including the already entered data will appear, and the correct information may then be modified within the box 1502. This is more fully illustrated in FIG. 16 wherein the pop-up window 1602 includes the data entry fields for an already existing handset. The data entry fields are the same as those described with respect to FIG. 15.

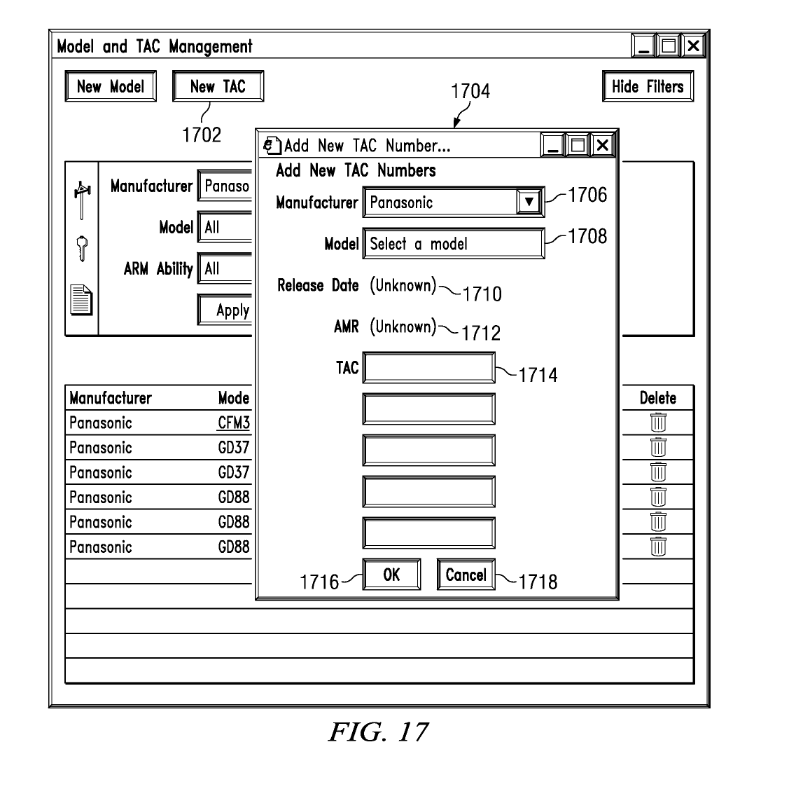

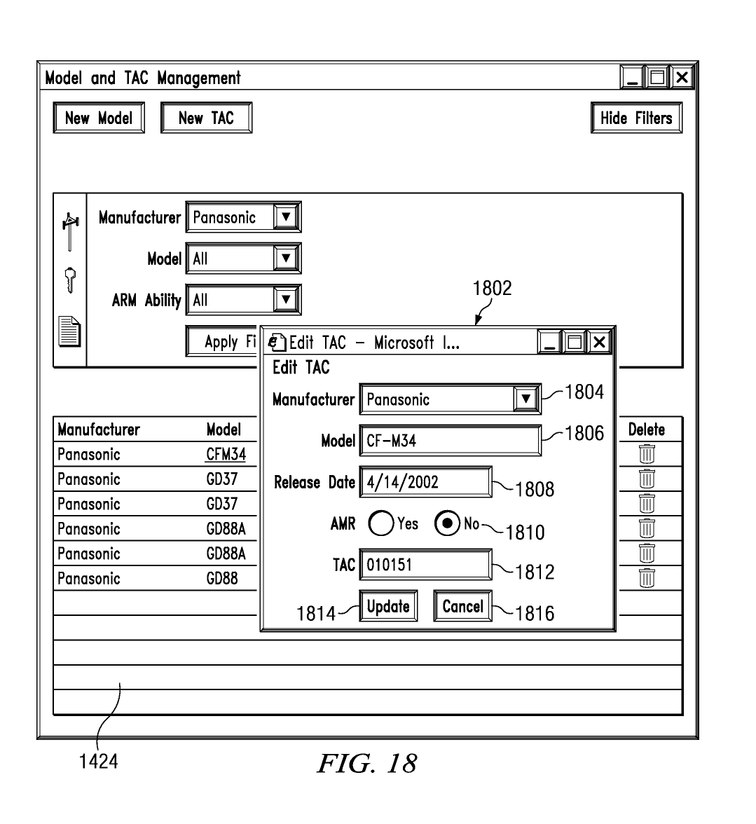

Referring now to FIGS. 17 and 18, there are two methods for entering TAC information into the handset information database through the handset data functionality 1314. By selecting the new TAC button 1702, an add new TAC pop-up screen 1704 will appear as illustrated in FIG. 17. The add new TAC screen 1704 provides a drop-down menu 1706 for entering manufacturer information and a drop-down menu 1708 for entering model information. Model information for release date and AMR capabilities may be entered in the release date field 1710 and AMR field 1712, respectively. The TAC fields 1714 provide locations for entering the TAC identifiers associated with a model. These new entries may be saved by clicking on the OK button 1716 or cancelled by selecting the Cancel button 1718. The TAC information for an existing handset may be edited by clicking on the handset within the results window 1424. This causes the appearance of the edit TAC information window 1802, as shown in FIG. 18, which includes the relevant data for the selected handset in the form of the manufacturer drop-down menu 1804, model drop-down menu 1806, release date field 1808, AMR fields 1810 and TAC field 1812. This information may be changed and updated or canceled using the Update and Cancel buttons 1814 and 1816, respectively.

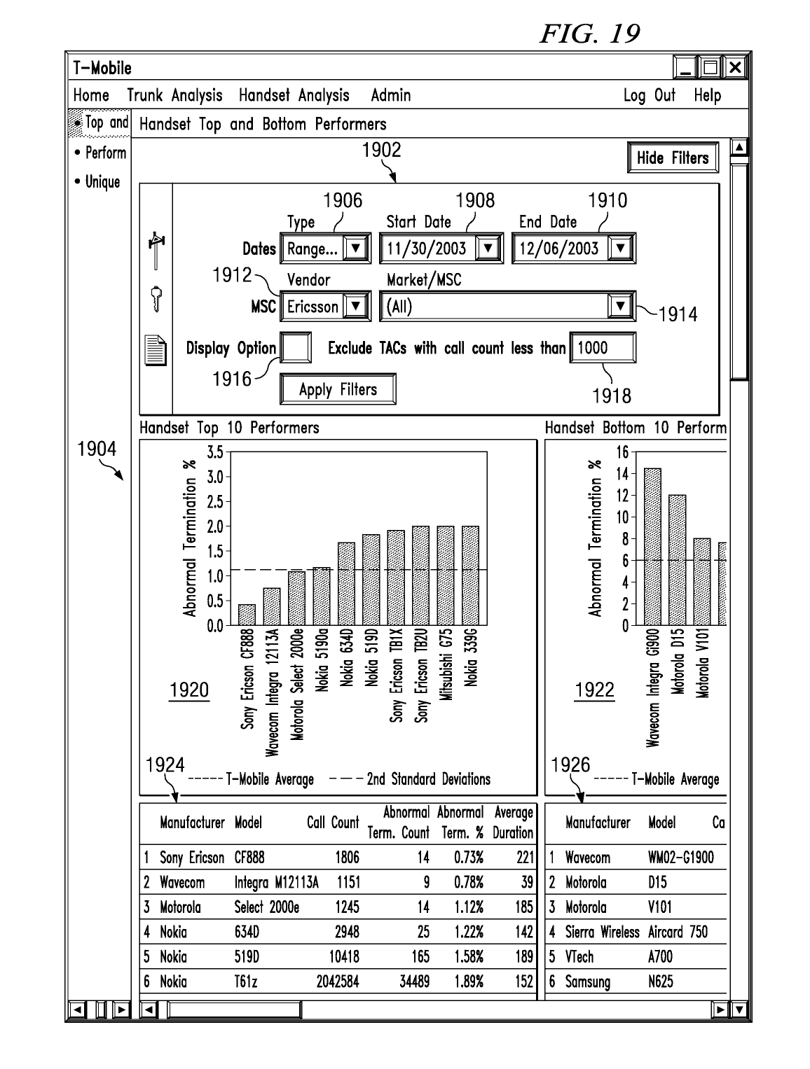

The handset analysis functionality 1312 additionally includes a Top and Bottom Performance functionality 1316 enabling the display of a number of performance reports for top and bottom performing handsets. A handset top and bottom performers screen as illustrated in FIG. 19 shows the traffic flow along the entire path of a terminating call for a number of different handsets. The end points of a call (terminating route and end cell) provide an understanding of the geographic dispersion of terminated traffic. The fields and the report include the handset originating route indicating that the inbound route to the MSC that the handset call to the subscriber came in on; the NPA-NXX of the subscriber that was called; and the terminating route comprising the A-interface route from which the call was terminated.

A filter box 1902 includes information for establishing the type of information to be displayed in the results window 1904. The date fields enable establishment of the type of date to be displayed in field 1906, a starting date in field 1908 and an ending date field 1910. The MSC fields enable selection of a vendor 1912 for desired MSCs and a model of the MSC in field 1914. Field 1916 enables the exclusion of TACs with a count less than a designated value in field 1918. The results window 1904 provides both graphical charts and tabular charts for the top ten handset performers and the bottom ten handset performers. The top ten handset performer graphical chart 1920 provides an indication of the number of abnormal terminations for a number of handset types in bar-graph format. Likewise, the handset bottom ten performer graphical chart 1922 provides an indication of the number of abnormal transmission terminations with respect to the bottom ten performing handsets in bar-graph format. The handset top ten performers tabular chart 1924 includes columns providing information on the manufacturer of the handset, the model of the handset, the number of calls taken by the handset, the number of abnormal call terminations for that handset and a percentage of abnormal terminations based upon the number of calls. Additionally, the average duration of calls on the handset is provided. The bottom ten performing handset tabular chart 1926 provides the same information for the worst performing handsets.

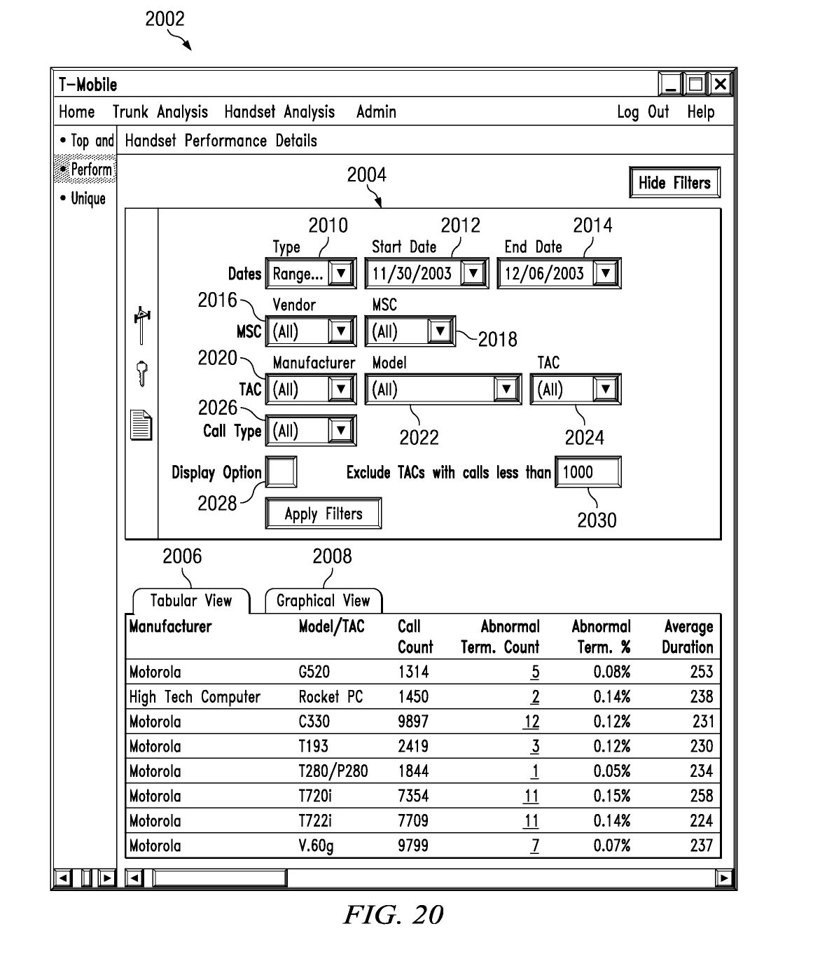

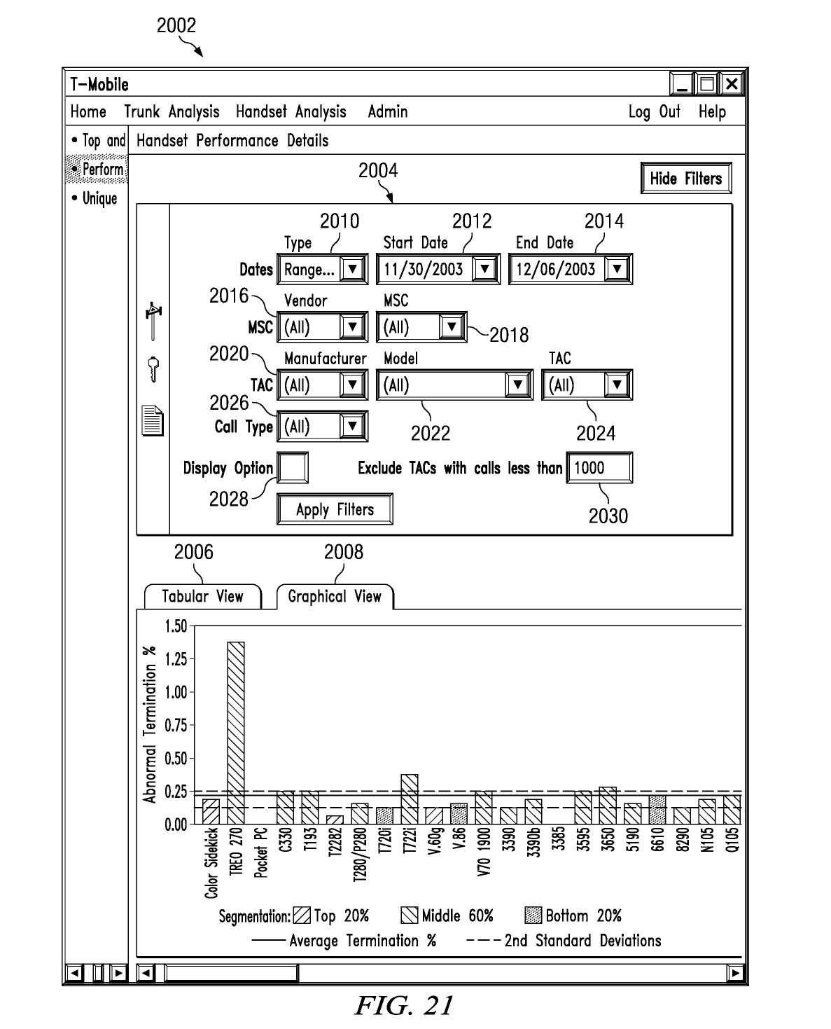

Referring now to FIG. 20, there is illustrated the handset performance details screen 2002 of the handset performance details functionality 1318. The handset performance details screen 2002 includes a filter box 2004 for selecting the data to be viewed within either the tabular view 2006 or the graphical view 2008. This enables the display of performance data for any desired group of handsets. The reports show the distribution of mobile terminal traffic to each base station controller from each incoming route by NPA-NXX on an incoming route. The filter box 2004 includes a dates area including a type of date field 2010, a start date field 2012 and an end date field 2014. MSCs may be selected according to a vendor field 2016 and a model of MSC type field 2018. The TACs associated with various handsets may be filtered according to the manufacturer field 2020 for identifying the manufacturer, a model field 2022 for identifying model types and a TAC number identifier 2024 for specific TAC numbers. Call types may be established in the call type field 2026. Field 2028 may be selected to exclude TACs having a number of calls less than established values set in field 2030.

The tabular view 2026 displays the performance detail for each selected handset including information relating to the manufacturer, the model/TAC, the call count for the model, the abnormal termination count for the model, the percentage of abnormal terminations per terminal call and the average call duration for the handset. The graphical view 2008 comprises a graphical representation indicating for each of the displayed handset devices the percentage of abnormal call terminations. The bars of the graphical representation are color coded to indicate whether the handset unit is in the top 20%, the middle 60% or the bottom 20% of abnormal call terminations. The filter box 2004 is the same as that displayed with the tabular view 2026.

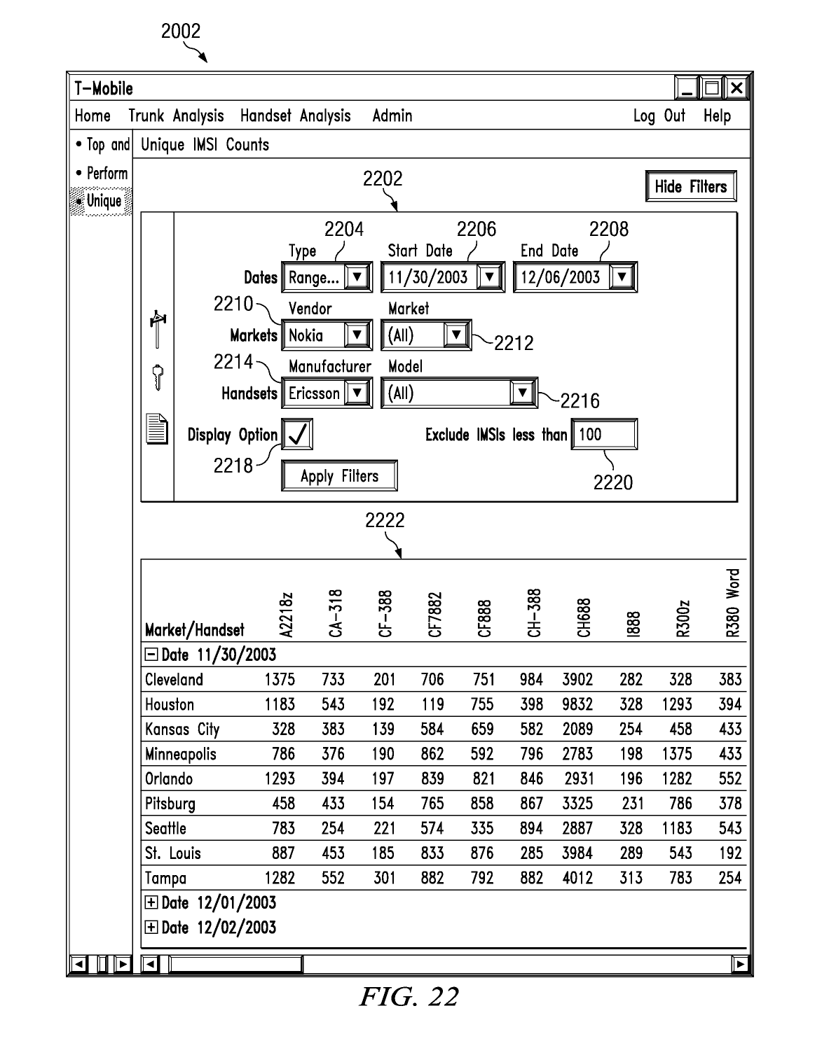

Referring now to FIG. 22, there is illustrated the Unique IMSI Counts screen provided by the Unique Handset Data functionality 1320. The Unique IMSI Counts screen is provided by the Unique Handset Data Functionality 1320 to provide information on specific handsets. This screen shows the traffic flow between MSC terminating circuits and the destination number exchange. The filters box 2202 includes date fields for a date type 2204, a starting date 2206 and an ending date 2208 of the data extraction. The markets fields enable entry of a filter with respect to the vendor 2210 and the market 2212 to select specific switches. Handset related fields include listing of a manufacturer field 2214 and a model field 2216 related to specific handsets. Display options include a field 2218 for excluding IMSIs (International Mobile Subscriber Identity) with less than a value in an established number field 2220. The IMSI account display 2222 includes a vertical column listing each of the searched markets for particular dates. Thus, for the date Nov. 30, 2003, the markets listed are Cleveland, Houston, Kansas City, Minneapolis, Orlando, Pittsburgh, Seattle, St. Louis and Tampa. Along the horizontal columns are listed various handset types used in these markets. The location where the handset type columns and market rows intersect indicate the number of calls served for a particular type of handset within that market on the associated date at the designated time period. Thus, for example, within the Houston market for the CF688 handset, 755 calls were served on Nov. 30, 2003.

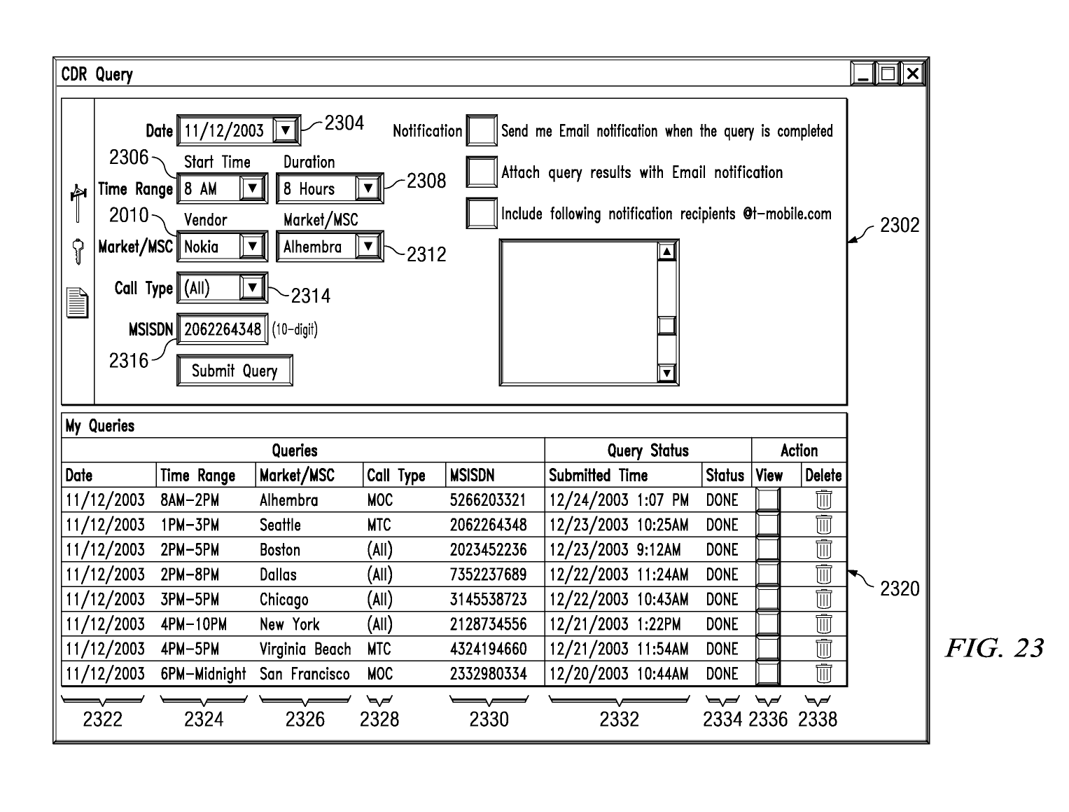

Referring now to FIG. 23, there is illustrated the (call data record) query screen provided by the Handset Query Functionality 1321. This report shows the traffic flow between MSC terminating circuits and the destination number exchange. The CDR query includes a filter box 2302, a date field 2304 within the filter box enables a particular date to be established. Time range fields enable the establishment of a start time 2306 and a duration 2308 from which data is to be extracted. The market/MSC field enables the establishment of the vendor 2310 of the MSC and the particular market 2312 where the MSC is located from which data is to be extracted. The call type field 2314 may search on either a mobile originated calls, mobile terminated calls, or both types of calls. The MSISDN field 2316 enables a search to be made on a particular mobile station identification number.

The manner of notification of the query results may be established by the requester of the search. The notification fields include an indication 2317 that an e-mail notification be sent when the query is completed. An attachment field 2018 is used to indicate that the query results are to be attached to the e-mail notification, and a recipients field 2019 is used to indicate additional recipients of the query results.

Display field 2320 provides a display of the number of query results. The date column 2322 provides an indication of the date on which the query was requested. The time range column 2324 provides the time range encompassed by the query. The market MSC column 2326 provides an indication of the market in which the MSC for the query resides. The call type column 2328 provides an indication of the call type for which the query was made, and the MSISDN column 2330 provides the identification number of the mobile station for which the query was made. The submitted time column 2332 indicates the time at which the query was made. The status column 2334 provides an indication of whether or not the query has been completed. Action columns include the view buttons 2336 enabling an individual to view the results of the provided query and the delete buttons 2328 enabling the query results to be deleted. The CDR query results are useful in providing particular results related to a specific handset device at a particular period in time. Thus, if a customer returned their cell phone complaining that my calls are always cutting out at particular times, the system may be used to query and obtain results for the particular cell phone at these specific time periods. This information may then be used by a repair facility to trouble shoot the telephone and determine the causes of the undesired call terminations.

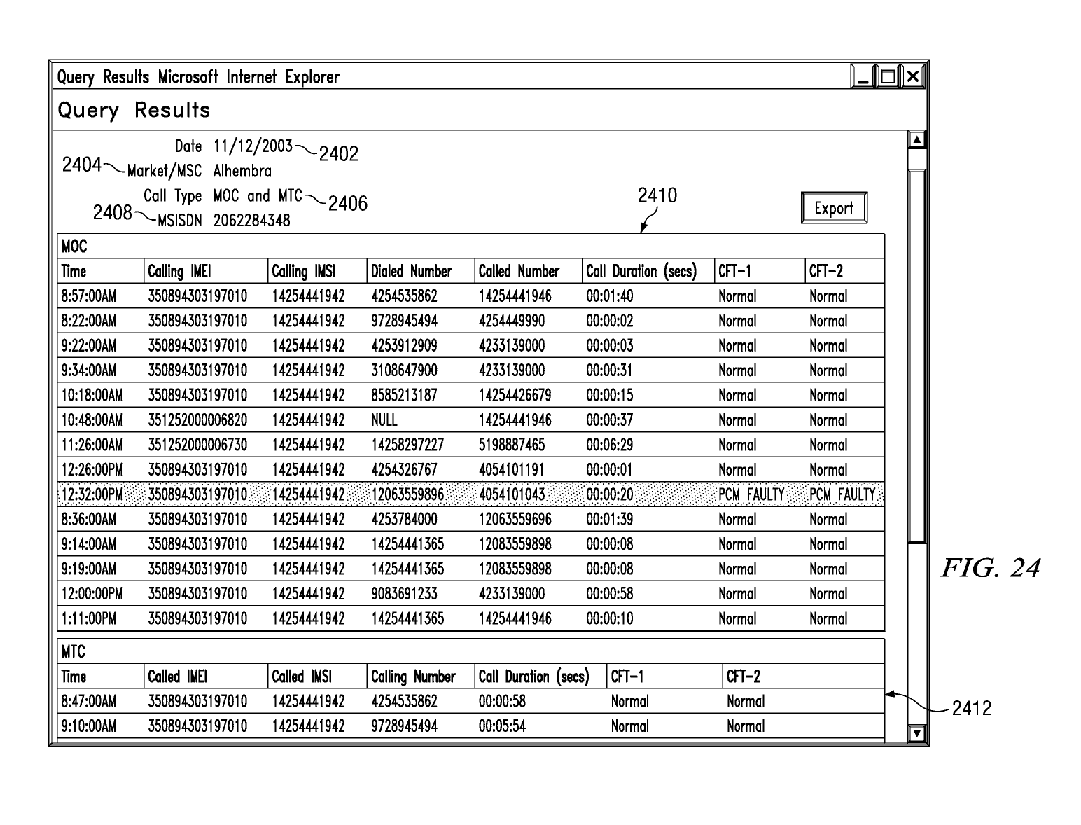

Referring now to FIG. 24, there is illustrated the query results which may be accessed by pressing the View button 2336 of the CDR query screen. The CDR results screen includes a date field 2402 for indicating the date the query results were created. A market/MSC field 2404 indicates the location of the MSC for which the information is provided. The call type field 2406 indicates whether the provided call type information provides mobile originated calls, mobile terminated calls or both. The MSISDN field 2408 provides the mobile station identifier with which the query results are associated. The query results in this particular example include a mobile originated call portion 2410 and a mobile terminated call portion 2412. While on the present example both mobile originated calls and mobile terminated calls are illustrated, it should be appreciated that only one or the other types of these calls may be provided with respect to any particular query result. For the mobile originated call portion 2410, a number of columns provide various information concerning the particular handset for which data was extracted. A time column provides information indicating the time a call was made. The calling IMEI number provides the associated IMEI number for the mobile handset initiating a call. The calling IMSI number provides an indication of the IMSI of the calling handset. The dialed number column provides an indication of the number being dialed by the handset. The called number column provides an indication of the number that was actually called by dialing the dialed number indicated in the previous column. The call duration column provides an indication of the length of the call that was initiated. The CFT-1 and CFT-2 columns indicate the diagnostic and termination reason.

The mobile terminating call portion 2412 also includes a number of columns providing various information about the extracted calls. The time column provides an indication of the point at which the call was made. The called IMEI number provides the IMEI of the calling number. The IMSI number provides an indication of the called IMSI. The calling number column provides an indication of the number making the terminated call. The call duration column provides an indication of the length of the call. The CFT-1 and CFT-2 columns provide an indication of diagnostic and termination reason.

It will be appreciated by those skilled in the art having the benefit of this disclosure that this invention provides a system for managing wireless call data. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A system for tracking handset operations within a wireless network, comprising:
an interface with a database containing call data relating to handset operations, the call data collected from call data records;
an extraction module for analyzing the call data within the database to obtain mobile originating call data and mobile terminating call data responsive to designated filter conditions;
a second database for storing the mobile originating call data and mobile terminating call data;
a user interface enabling a user to create the designated filter conditions and utilize the mobile originating call data and the mobile terminating call data to provide at least one handset report describing operation of at least one handset.

2. The system of claim 1, wherein the user interface provides a first graphical user interface for entering handset specific data.

3. The system of claim 2, wherein the first user interface further includes a filter function enabling entry of the designated filter conditions.

4. The system of claim 3, wherein the first graphical user interface enables generation of a list of handsets responsive to the designated filter conditions entered in the filter function, the mobile originating call data and the mobile terminating call data.

5. The system of claim 2, wherein the first graphical user interface further enables updating of previously entered handset specific data.

6. The system of claim 1, wherein the user interface provides a second graphical user interface displaying a predetermined number of best and worst performing handsets responsive to the designated filter conditions, the mobile originating call data and the mobile terminating call data.

7. The system of claim 6, wherein the second graphical user interface further includes a filter function enabling entry of the designated filter conditions.

8. The system of claim 6, wherein the second graphical user interface includes a first option for displaying the predetermined number of best and worst performing handset in a tabular format.

9. The system of claim 6, wherein the second graphical user interface includes a second option for displaying the predetermined number of best and worst performing handset in a graphical format.

10. The system of claim 1, wherein the user interface provides a third graphical user interface for displaying traffic levels for a plurality of designated switches with respect to a plurality of designated handsets responsive to the designated filter conditions, the mobile originating call data and the mobile terminating call data.

11. The system of claim 10, wherein the third graphical user interface further includes a filter function enabling entry of the designated filter conditions including the designated switches and the designated handsets.

12. The system of claim 10, wherein the third graphical user interface includes a first option for displaying the traffic levels for a plurality of designated switches with respect to a plurality of designated handsets in a tabular format.

13. The system of claim 10, wherein the third graphical user interface includes a second option for displaying the traffic levels for a plurality of designated switches with respect to a plurality of designated handsets in a graphical format.

14. The system of claim 1, wherein the user interface provides a fourth graphical user interface for displaying at least one query defined by the designated filter conditions.

15. The system of claim 14, wherein the user interface provides a fifth graphical user interface illustrating results of a query, the results accessible via the fourth graphical user interface, the results including at least one of mobile originating calls associated with the handset and mobile terminating calls associated with the handset.

16. The system of claim 14, wherein the fourth user interface further includes a filter function enabling entry of the designated filter conditions, the designated filter conditions defining the at least one query that is to be displayed.

17. The system of claim 16, wherein the filter function enables designation of an email notification and designation of additional recipients of query results.

18. A system for tracking handset operations within a wireless network, comprising:
an interface with a database containing call data relating to handset operations, the call data collected from call data records;
an extraction module for analyzing the call data within the database to obtain mobile originating call data and mobile terminating call data responsive to designated filter conditions;
a second database for storing the mobile originating call data and mobile terminating call data;
a user interface enabling a user to create the designated filter conditions and utilize the mobile originating call data and the mobile terminating call data, the user interface providing:
a first graphical user interface for entering handset specific data;
a second graphical user interface displaying a predetermined number of best and worst performing handsets responsive to the designated filter conditions, the mobile originating call data and the mobile terminating call data;
a third graphical user interface for displaying traffic levels for a plurality of designated switches with respect to a plurality of designated handsets responsive to the designated filter conditions and the mobile originating call data and the mobile terminating call data;
a fourth graphical user interface for displaying at least one query defined by the designated filter conditions;
a fifth graphical user interface illustrating results of a query, the results accessible via the fourth graphical user interface, the results including at least one of mobile originating calls associated with the handset and mobile terminating calls associated with the handset.

19. The system of claim 18, wherein the first user interface further includes a filter function enabling entry of the designated filter conditions.

20. The system of claim 19, wherein the first graphical user interface enables generation of a list of handsets responsive to the designated filter conditions entered in the filter function, the mobile originating call data and the mobile terminating call data.

21. The system of claim 18, wherein the first graphical user interface further enables updating of previously entered handset specific data.

22. The system of claim 18, wherein the second graphical user interface further includes a filter function enabling entry of the designated filter conditions.

23. The system of claim 18, wherein the second graphical user interface includes a first option for displaying the predetermined number of best and worst performing handset in a tabular format.

24. The system of claim 18, wherein the second graphical user interface includes a second option for displaying the predetermined number of best and worst performing handset in a graphical format.

25. The system of claim 18, wherein the third graphical user interface includes a first option for displaying the traffic levels for a plurality of designated switches with respect to a plurality of designated handsets in a tabular format.

26. The system of claim 18, wherein the third graphical user interface includes a second option for displaying the traffic levels for a plurality of designated switches with respect to a plurality of designated handsets in a graphical format.

27. The system of claim 18, wherein the fourth graphical user interface further includes a filter function enabling entry of the designated filter conditions, the designated filter conditions defining the at least one query that is to be displayed.

28. The system of claim 18, wherein the filter function enables designation of an email notification and designation of additional recipients of query results.
